(19) United States
(12) Patent Application Publication
(10) Pub. No.: US 2016/0180304 A1
(43) Pub. Date: Jun. 23, 2016

(54) COMBINED ELECTRONIC PAYMENT AND TRANSFER FOR DIGITAL BANKING CHANNELS

(71) Applicant: BBVA Compass Bancshares, Inc., Houston, TX (US)

(72) Inventors: Alejandro E. Carriles, Houston, TX (US); Michael F. Kehres, Birmingham, AL (US); Jacob B. Sanders, Birmingham, AL (US)

(73) Assignee: BBVA Compass Bancshares, Inc., Houston, TX (US)

(21) Appl. No.: 14/973,216

(22) Filed: Dec. 17, 2015

Related U.S. Application Data
(60) Provisional application No. 62/093,376, filed on Dec. 17, 2014.

(51) Int. Cl. G06Q 20/10; G06Q 20/40

(52) U.S. Cl. CPC G06Q 20/102; G06Q 20/405; G06Q 20/401

(57) ABSTRACT

Methods, systems, and apparatuses for combined electronic payment and transfer for digital banking channels are described. The described embodiments provide a user-facing system for sending money from one account to another account over any one of multiple money movement rails. The embodiments simplify traditional money movement processes, by presenting the user with certain selectable characteristics for the transaction, and then automatically selecting an appropriate money movement rail in the background. The result is a simplified and more intuitive user experience for money movement transactions.

### RELATED APPLICATION

This application claims priority under 35 U.S.C. §119 to U.S. Provisional Application No. 62/093,376, entitled “Combined Electronic Payment and Transfer for Digital Banking Channels,” by Alejandro E. Carriles, Michael F. Kehres and Jacob B. Sanders, filed 17 Dec. 2014 (Atty. Docket No.: BBVA.2001.USPR1), the contents of which are herein incorporated by reference in their entirety.

### BACKGROUND OF THE INVENTION

1. Field of the Invention

This invention relates to electronic payments and more particularly relates to a new way to schedule, process, review, and manage electronic payments and transfers, as well as the source and destination accounts, utilizing a digital banking channel, such as but not limited to Mobile Banking, Online Banking, Automatic Teller Machines (ATM), and Interactive Voice Response (IVR).

2. Description of the Related Art

The current state of the prior art for issuing electronic payments and/or transfers requires the user to begin by selecting the method that would be utilized to perform such action. For example, to move money from an internal DDA (Demand Deposit Account), such as a checking, savings or Money Market account, to an external account (an account kept at a different bank than where the originating account resides), the user must first select the method that would be used from a list of options. The options, in this example, could be Send a Wire, Send an Automated Clearing House (ACH) Electronic Transfer, Send a Personal Payment (P2P), etc.

A typical prior online banking application uses a list of menu options to perform an Electronic Payment or Transfer, including Transfer Within Bank, Transfer from External Account, Transfer to External Account, Domestic Wires, International Transfers, Bill Pay, and Person-to-Person Transfer. Other prior systems display options of “Transfer Money,” “Pay Bills,” and “Wire Transfer.” The prior art typically first presents a list of numerous payment methods, one of which must be selected to execute the transaction as the required first step to perform any transfer action. The user is required to decide on the type of processing that would be required to move the money from one account to another using one of the displayed options. This is problematic because most consumers do not know the difference between a transfer within bank, third party accounts (3PT), wire transfers, etc., which creates confusion, anxiety, and, ultimately, originating problems in the transaction by selecting an option that may not be the correct or ideal method to perform the money movement the user desired.

### Underlying Operations

As discussed, the prior art money movement processes start by selecting a method to move the money. The reason behind this is that those different methods or “rails” to move the money are, in most cases, independent software applications and processes that do not communicate with each other. The databases that hold the payee information for a particular payment method, for example Wire Transfer, ACH (Automated Clearing House) or P2P (Person to Person) are independent of each other, requiring duplicate identification information such as the name of the payee or recipient, as well as the account identification elements, such as the account number, and a particular identifying element related intrinsically to the payment method selected. For example, most large banks have a Routing number required to receive payments processed via a Wire Transfer, but would require a different number if that same payment was sent via an ACH Transfer.

An additional problem with the existing payment processes is that in many cases, the different payment methods utilize software solutions from different vendors, making their data incompatible due to different file formats and inconsistent records. Adding to this complexity, new payment methods, coming to the market in this digital age, such as P2P (Person to Person) bring a particular challenge, as they require a completely different dataset to identify the recipient. In this case, instead of an account number, the user only needs to have the receiver's email address, mobile number, debit card number or any other alternative method of identification. One such type of identification can be based on social media profiles such as, but not limited to, a Twitter handle or Facebook profile. As all of these payment methods or rails have been developed over time, banks have simply added individual options or hyperlinks to access each one of them and have not provided an integrated approach both from the front end and the back end.

### User Experience

As these different payment methods have in most cases technical, or banking names, the average user/consumer does not know the difference between moving money using one method or another. Most frequently a user needs to select one payment option and after following a few steps obtain the particular limits, speed and cost, and then determine if that is what best suits the user's needs. Even worse, if a user had added a particular payee or destination account previously in order to move money to that account using a specific method, when trying to use an alternative method they discover that none of the previous information is available, due to the fact that each process houses the required account information in different databases independent of each other. As more payment methods are developed and added, the complexity, confusion, and inoperability grows for the user.

As another problem with the existing prior art, the use of colloquial terms by consumers to identify certain types of transactions clashes with the traditional banking terminology. For example, in order to pay a credit card balance, a user could transfer money from their checking account to the credit card account. Unfortunately, most consumers do not associate this type of transfer with a payment. The option to pay a credit card with an internal transfer is not easily understood by customers, who sometimes indicate that “they do not want to transfer money to their credit card, they want to pay it.” In this case, such a transfer and a payment would be the same thing, but may be unknown to an average customer.

### Tracking Transactions

The independent nature of these electronic transactions, originated by multiple and different systems, makes it necessary for the user to remember which method or function was used to make the transaction, as the transaction history associated to each of these operations is also stored typically in separate databases. For this reason, if a user needs to research a particular transaction, it is not enough to know who was the recipient of the funds, but also how those funds were moved. Otherwise, the user will be required to navigate thru multiple payment options, looking at the past transactions submitted by each of them until the desired transaction could be located, making this a time consuming process, resulting in a negative customer experience.

A need exists for an improved method and system for processing financial transactions, and in particular one that provides an improved association of financial data and payment choices that eliminates the likelihood of user errors when transferring money. A new system is needed that is more integrated with the bank's databases and user accounts, offers integration with all types of money payment methods, provides improved transaction tracking capabilities, and allows an improved user interface.

### SUMMARY

Methods, systems, and apparatuses for combined electronic payment and transfer for digital banking channels are described. In an embodiment, a method includes receiving, over a communication interface to a remote user interface device, a selection of a source account for a money movement transaction between a source account server and a destination account server. The method may also include receiving, over the communication interface to the remote user interface device, a selection of a destination account for a transaction between a source account server and a destination account server. Additionally, the method may include receiving, over a communication interface, one or more transaction parameters for the transaction between the source account server and the destination account server. The method may include determining, using a processing device, one or more transaction rails suitable for conducting the transaction in response to the transaction parameters. Also, the method may include generating, using a processing device, one or more transaction characteristics for presentation to a user. In such embodiments, the method may include receiving one or more selected transaction characteristics from the user. Additionally, the method may include scheduling the transaction between the source account server and the destination account server over a transaction rail determined in response to the selected transaction characteristics.

An embodiment of an apparatus for combined electronic payment and transfer for digital banking channels may include a communication interface coupled to a remote user interface device and a processing device. In an embodiment, the communication device may receive a selection of a source account for a money movement transaction between a source account server and a destination account server, receive a selection of a destination account for a transaction between a source account server and a destination account server, and receive one or more transaction parameters for the transaction between the source account server and the destination account server. In an embodiment, the processing device may determine one or more transaction rails suitable for conducting the transaction in response to the transaction parameters, generate one or more transaction characteristics for presentation to a user, receive one or more selected transaction characteristics from the user, and schedule the transaction between the source account server and the destination account server over a transaction rail determined in response to the selected transaction characteristics.

Embodiments of a system for combined electronic payment and transfer for digital banking channels may include a user interface device configured to operate a banking and payments application, and an application server in communication with the user interface device. In an embodiment, the application server may include a communication interface coupled to a remote user interface device. The communication interface may receive a selection of a source account for a money movement transaction between a source account server and a destination account server, receive a selection of a destination account for a transaction between a source account server and a destination account server, and receive one or more transaction parameters for the transaction between the source account server and the destination account server. Also, the application server may include a processing device coupled to the communication interface. In an embodiment, the processor may determine one or more transaction rails suitable for conducting the transaction in response to the transaction parameters, generate one or more transaction characteristics for presentation to a user, receive one or more selected transaction characteristics from the user, and schedule the transaction between the source account server and the destination account server over a transaction rail determined in response to the selected transaction characteristics.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 is a schematic block diagram illustrating one embodiment of a system for combined electronic payment and transfer for digital banking channels.

FIG. 2 is a schematic block diagram illustrating one embodiment of a data architecture for combined electronic payment and transfer for digital banking channels.

FIG. 3 is a schematic block diagram illustrating one embodiment of an apparatus configured for combined electronic payment and transfer for digital banking channels.

FIG. 4 is a schematic diagram illustrating an embodiment of a network architecture for combined electronic payment and transfer for digital banking channels.

FIG. 5 is a schematic block diagram illustrating an embodiment of an apparatus for combined electronic payment and transfer for digital banking channels.

FIG. 6 is a schematic flowchart diagram illustrating an embodiment of a method for combined electronic payment and transfer for digital banking channels.

FIG. 7A is a schematic flowchart diagram illustrating an embodiment of a method for combined electronic payment and transfer for digital banking channels.

FIG. 7B is a schematic flowchart diagram illustrating a continuation of the method of FIG. 7A.

FIG. 8 is a schematic flowchart diagram illustrating an embodiment of a method for combined electronic payment and transfer for digital banking channels.

FIG. 9A is a schematic flowchart diagram illustrating an embodiment of a method for combined electronic payment and transfer for digital banking channels.

FIG. 9B is a schematic flowchart diagram illustrating a continuation of the method of FIG. 9A.

FIG. 10 is a schematic flowchart diagram illustrating an embodiment of a method for combined electronic payment and transfer for digital banking channels.

FIG. 11 is a schematic flowchart diagram illustrating an embodiment of a method for combined electronic payment and transfer for digital banking channels.

FIG. 12 is a screenshot diagram illustrating one embodiment of a user interface for managing accounts.

FIG. 13 is a screenshot diagram illustrating one embodiment of a user interface for managing accounts.

FIG. 14 is a screenshot diagram illustrating one embodiment of a user interface for managing accounts.

FIG. 15 is a screenshot diagram illustrating one embodiment of a user interface for managing accounts.

FIG. 16A is a partial screenshot diagram illustrating one embodiment of a user interface for managing accounts.

FIG. 16B is a partial screenshot diagram illustrating one embodiment of a user interface for managing accounts.

FIG. 17 is a screenshot diagram illustrating one embodiment of a user interface for managing accounts.

FIG. 18A is a screenshot diagram illustrating one embodiment of a mobile user interface for conducting a money transfer transaction.

FIG. 18B is a screenshot diagram illustrating one embodiment of a user interface for conducting a money transfer transaction.

FIG. 19A is a screenshot diagram illustrating one embodiment of a mobile user interface for conducting a money transfer transaction.

FIG. 19B is a screenshot diagram illustrating one embodiment of a user interface for conducting a money transfer transaction.

FIG. 20A is a screenshot diagram illustrating one embodiment of a mobile user interface for conducting a money transfer transaction.

FIG. 20B is a screenshot diagram illustrating one embodiment of a mobile user interface for conducting a money transfer transaction.

FIG. 20C is a screenshot diagram illustrating one embodiment of a mobile user interface for conducting a money transfer transaction.

FIG. 21 is a screenshot diagram illustrating one embodiment of a mobile user interface for conducting a money transfer transaction.

FIG. 22 is a screenshot diagram illustrating one embodiment of a user interface for conducting a money transfer transaction.

FIG. 23 is a screenshot diagram illustrating one embodiment of a user interface for reviewing money transfer transaction information.

### DETAILED DESCRIPTION

Various features and advantageous details are explained more fully with reference to the nonlimiting embodiments that are illustrated in the accompanying drawings and detailed in the following description. Descriptions of well-known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure.

For ease of reference, the following table provides descriptions for various abbreviations used in this disclosure:

TABLE 1

| Name | Description |
|---|---|
| 3PT | Third Party Transfer |
| A2A | External Account to Account Transfer |
| ALS | Alnova Installment Loan Account |
| CC | Credit Card Account |
| DDA | Demand Deposit Account (i.e., Checking) |
| HELOC | Home Equity Line of Credit |
| LN | Loan |
| LOC | Line of Credit |
| MMA | Money Market |
| MTG | Mortgage |
| ODP | Overdraft Protection Account |
| PLC | Personal Line of Credit |
| SAV | Savings |
| SLOC | Signature Line of Credit |

### System Architecture

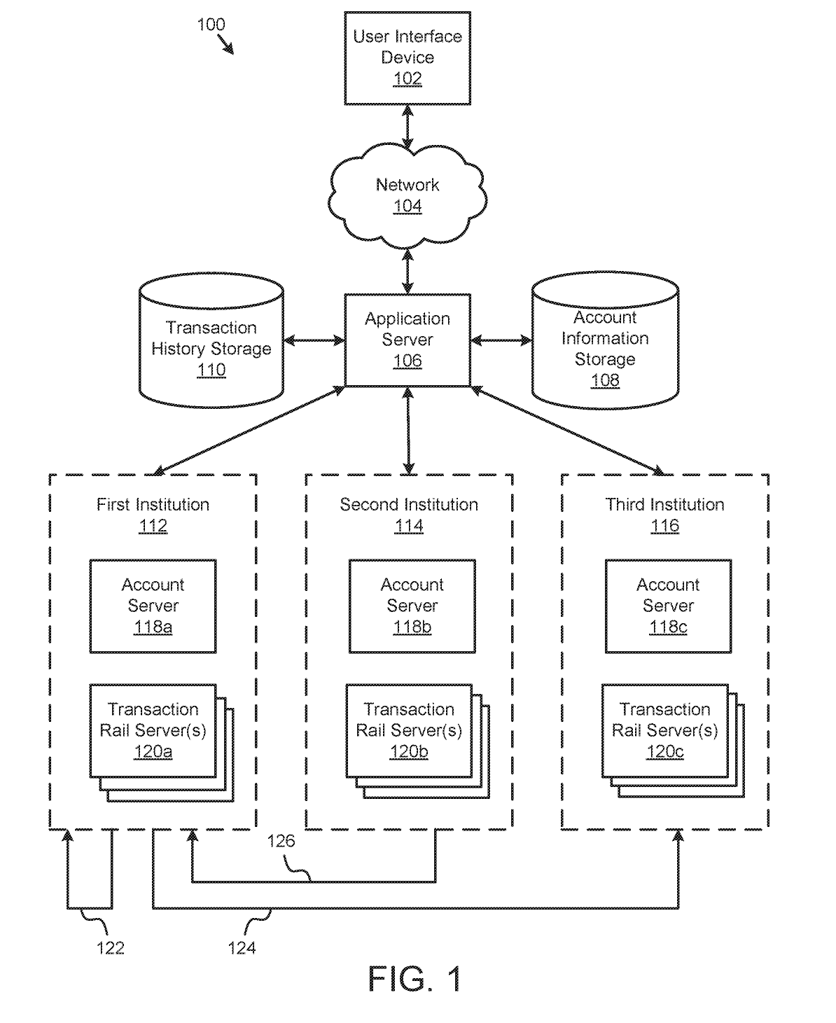

FIG. 1 is a schematic block diagram illustrating one embodiment of a system 100 for combined electronic payment and transfer for digital banking channels. In an embodiment, the system 100 includes a user interface device 102 and an application server 106 coupled by a network 104. The application server 106 may be coupled to one or more data storage device 108, 110. In an embodiment, the application server 106 may be further configured to communicate with account management infrastructure in one or more banking institutions. For example, in the depicted embodiment, the application server 106 may communicate with a first banking institution 112, a second banking institution 114, and a third banking institution 116. In each of the three banking institutions 112, 114, 116, the application server 106 may communicate with an account server 118a-c respectively and/or a transaction rail server 120a-c respectively. As used herein, the term “transaction rail” means a mode of transferring money from a first account to a second account. Examples of transaction rails include an electronic money transfer between internal DDA accounts, ACH transfers, wire transfers, P2P transfers, electronic check transfers, etc. One of ordinary skill will recognize a variety of electronic money transfer rails which may be used in accordance with the present embodiments.

In an embodiment, the application server 106 may host a payments and transfers application, as described in the present embodiments. The user interface device 102 may download application code from the application server 106. A user of the user interface device 102 may use the application to set up one or more source accounts and one or more destination accounts. For example, the user may provide account setup information required to allow the application server 106 to communicate the account server 118a at the first institution 112, and further to allow a money transfer or payment via one or more of the transaction rail servers 120 at the first institution 112. In such an embodiment, a first account managed by the account server 118a may be designated as a source account.

Although the application server 106 is depicted as separate from any institution, one of ordinary skill will recognize that the application server 106 may be hosted and/or managed internally by any of the institutions 112, 114, 116. Alternatively, the application server 106 may be hosted or managed by a third-party organization, independent of any financial institution. In an embodiment, where the application server 106 is hosted by the first financial institution, however, the application server 106 may still be configured to communicate with account servers 118b-c and transaction rail servers 120b-c in the second institution 114 and the third institution 116 respectively. For example, the user my provide information required to authorize or verify access to the second institution 114 and the third institution 116.

The account information for each of the user's accounts stored in the account information storage 108 may include sufficient information to enable a money transfer or payment via one or more of a plurality of the transaction rails. For example, the account information 108 may include one or more source accounts, such as checking, savings, credit, or money market accounts. The source accounts may be managed by any of the account servers 118a-c at any of the institutions 112,114, 116, provided that the user gives sufficient authorization or validation information for setting up the accounts. Additionally, the application may prompt the user for all information required to send, for example, an ACH transfer, a wire transfer, and/or a P2P transfer, thereby enabling all of the information required by a plurality of transaction rail servers 120a-c to be stored in a single record for each source and destination account.

By way of example, a first account record may be stored in the account information storage 108 for a first source account. The first source account may be, for example, a checking account managed by the account server 118a of the first institution 112. In such an example, a second source account record may be stored in the account information storage 108 for a second source account managed by the account server 118b of the second institution 114. The second source account may be, for example, a savings account. A first destination account record may be stored in the account information store 108. The first destination account may be managed by the account server 118a of the first institution 112. For example, the first destination account may be a mortgage loan account. In such an example, a second destination account may be stored in the account information storage 108 for a second destination account managed by the account server 118c of the third institution 116. For example, the second destination account may be a credit account.

In such examples, the user may provide the account information via the user interface device 102, which then communicates the account information over the network 104 to the account storage for storage into the account information storage device 108. In another embodiment, the user interface device 102 may provide the information directly to the account information storage device 108 via a direct connection or a connection to a storage server (not shown) or cloud storage interface (not shown).

The user may then cause a first money transfer transaction to occur. As used herein, the term “transaction” means a transfer or payment of money, or other units of value, from a first account to a second account. For example, the user may schedule a recurring monthly transfer from the first source account, a checking account at the first institution 112, to the first destination account, a mortgage loan account at the first institution 112. The funds for the first money transaction may be transferred via a first transaction rail 122, which may be an Internal Mortgage Payment rail, for example.

In such an example, the user may further cause a recurring monthly transfer of funds from the first source account, a checking account at the first institution 112 to the second destination account, a credit account at the third institution to be carried out via a second transaction rail 124, such as an ACH transfer. The user may also cause a one-time transfer from the second source account, a savings account at the second institution 114 to be conducted over a third money transfer rail 126. For example, the third transaction rail 126 may be an A2A rail. Thus, in such an example, a single user may manage accounts and schedule transactions between a plurality of institutions using a common interface, and a consolidated set of account records stored in the account information storage device 108.

In a further embodiment, information about past transaction history, pending transactions, and scheduled or recurring transactions may be retrieved from the account servers 118a-c and/or from the transaction rail servers 120a-c by the application server 106, and stored in the transaction history storage 110. Thus, all transaction information for a plurality of rails can be aggregated into a single transaction history record and readily viewable by the user via the user interface device 102.

One of ordinary skill will recognize a variety of hardware devices that are suitable for use as a user interface device 102, including for example, a mobile data device, a tablet computer, a Personal Data Assistant (PDA), a laptop computer, or a desktop computer. One of ordinary skill will recognize additional or further embodiments of a user interface device, including for example, a wearable interface device, a telephone-based device, or an Automated Teller Machine (ATM).

One of ordinary skill will further recognize a wide variety of networks 104, which may be suitable for use with the present embodiments, including for example, the Internet, a Wide Area Network (WAN), a Local Area Network (LAN), a mobile data network, or the like. Although separate networks have not be illustrated between each of the various servers and storage devices shown in FIG. 1, one of ordinary skill will recognize that various network configurations may be employed. For example, account information storage 108 and transaction history storage 110 may be implemented in a cloud-based storage system, in a Storage Area Network (SAN), or the like. Further, the various servers may be connected by various network arrangements, including the Internet, WAN connections, or the like. In still further embodiments, the various servers may be stand-alone devices, or may be cloud-based servers or compute nodes in a cloud-based data center.

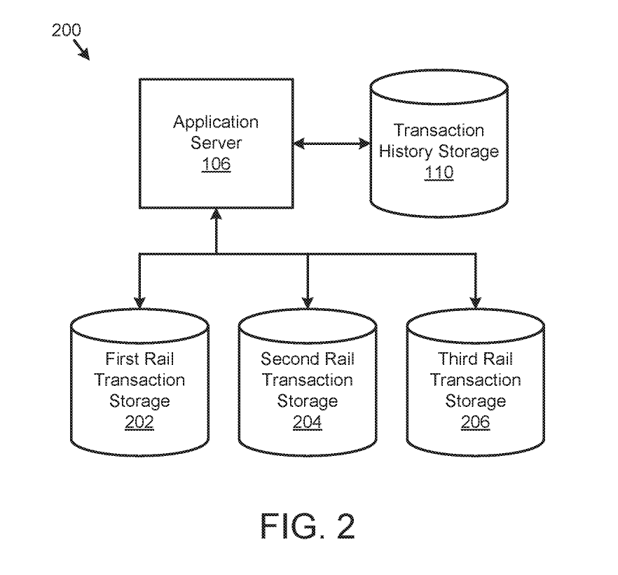

FIG. 2 is a schematic block diagram illustrating one embodiment of a data architecture for combined electronic payment and transfer for digital banking channels. The data architecture 200 of FIG. 2 illustrates how the transaction history information is consolidated into the transaction history storage device 110. In such an embodiment, information from a first rail transaction storage device 202, a second rail transaction storage device 204, and a third rail transaction storage device 206 are collected by the application server 106 and aggregated into the transaction history storage device 110.

For example, the first rail transaction storage 202 may contain information associated with transactions carried out, or scheduled to be carried out, over the first transaction rail 122. In the example described with reference to FIG. 1, the first transaction rail 122 was an Internal Mortgage Payment rail. Similarly, the second rail transaction storage 204 may store information associated with transactions carried out on the second transaction rail 124, an ACH rail in the described example. The third rail transaction storage 206 may include information associated with transactions carried out on the third transaction rail 126, an A2A (Account to Account) rail in the described example. Thus, when aggregated into the transaction history storage 110, the user may simultaneously view all transaction information for past, pending, or scheduled Internal Mortgage Payments, ACH and A2A transfer transactions over the user interface device 102.

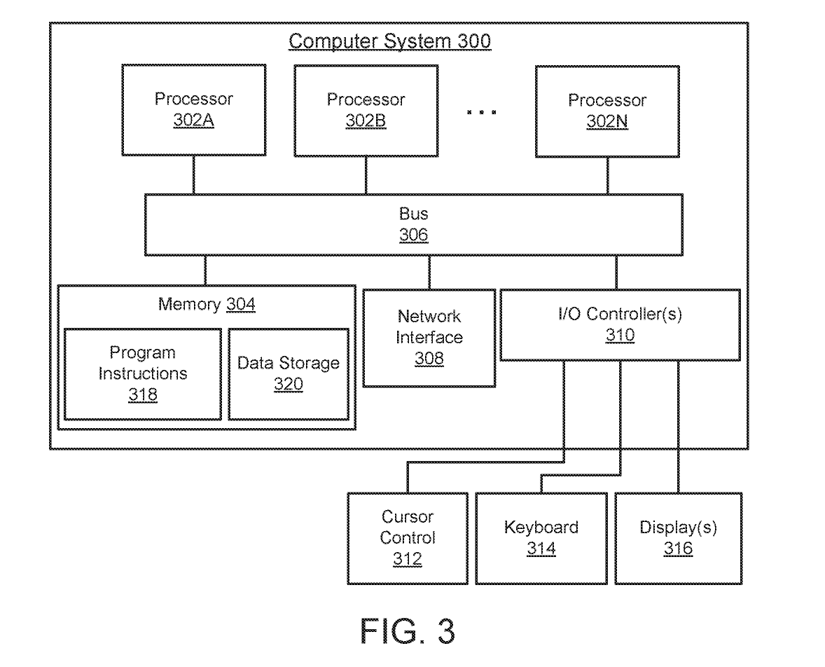

FIG. 3 is a schematic block diagram illustrating one embodiment of a computer system 300 configured for combined electronic payment and transfer for digital banking channels. In one embodiment, the user interface device 102 may be implemented on a computer system similar to the computer system 300 described in FIG. 3. Similarly, the application server 106 may be implemented on a computer system similar to the computer system 300 described in FIG. 3. Account servers 118a-c may also be implemented on a computer system similar to the computer system 300. Transaction rail servers 120a-c may also be implemented on a computer system similar to computer system 300. In various embodiments, computer system 300 may be a server, a mainframe computer system, a workstation, a network computer, a desktop computer, a laptop, mobile data device, or the like.

As illustrated, computer system 300 includes one or more processors 302A-N coupled to a system memory 304 via a data bus 306. Computer system 300 further includes network interface 308 coupled to bus 306, and input/output (I/O) controller(s) 310, coupled to devices such as cursor control device 312, keyboard 314, and display(s) 316. In some embodiments, a given entity (e.g., user interface device 102) may be implemented using a single instance of computer system 300, while in other embodiments multiple such systems, or multiple nodes making up computer system 300, may be configured to host different portions or instances of embodiments (e.g., application server 106).

In various embodiments, computer system 300 may be a single-processor system including one processor 302A, or a multi-processor system including two or more processors 302A-N (e.g., two, four, eight, or another suitable number). Processor(s) 302A-N may be any processor capable of executing program instructions. For example, in various embodiments, processor(s) 302A-N may be general-purpose or embedded processors implementing any of a variety of architectures, such as the x86, POWERPC®, ARM®, SPARC®, or MIPS® ISAs, or any other suitable architecture. In multi-processor systems, each of processor(s) 302A-N may commonly, but not necessarily, implement the same architecture. Also, in some embodiments, at least one processor(s) 302A-N may be a graphics processing unit (GPU) or other dedicated graphics-rendering device.

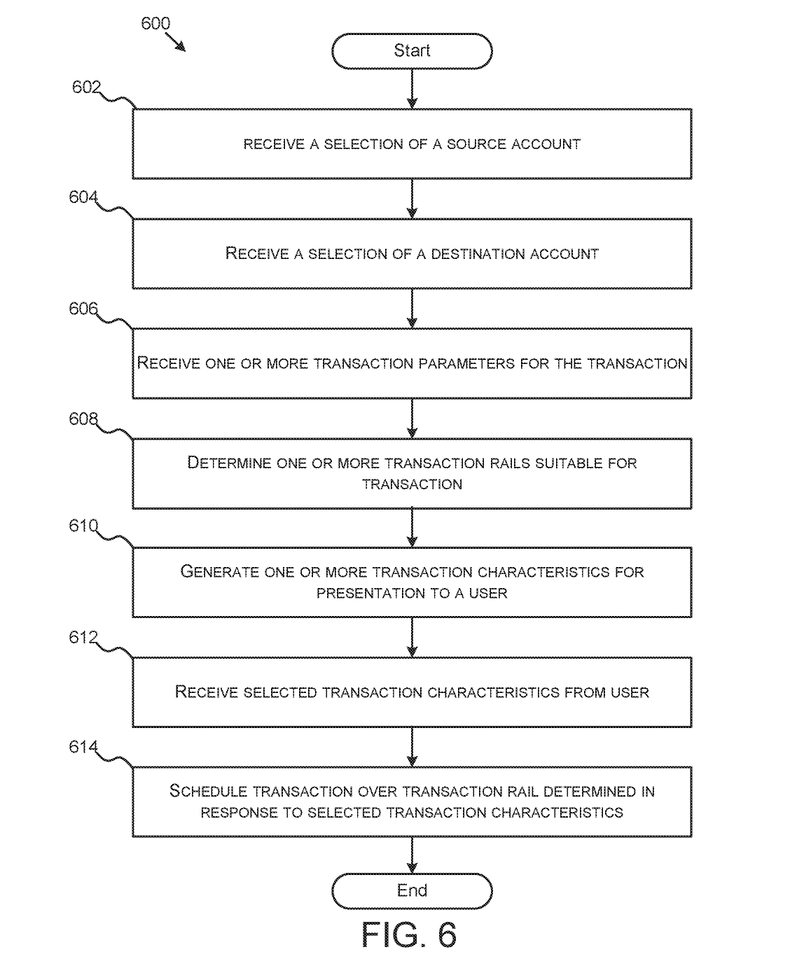

System memory 304 may be configured to store program instructions and/or data accessible by processor(s) 302A-N. For example, memory 304 may be used to store software program and/or database shown in FIGS. 6-11. In various embodiments, system memory 304 may be implemented using any suitable memory technology, such as static random access memory (SRAM), synchronous dynamic RAM (SDRAM), nonvolatile/Flash-type memory, or any other type of memory. As illustrated, program instructions and data implementing certain operations, such as, for example, those described above, may be stored within system memory 304 as program instructions 318 and data storage 320, respectively. In other embodiments, program instructions and/or data may be received, sent or stored upon different types of computer-accessible media or on similar media separate from system memory 304 or computer system 300. Generally speaking, a computer-accessible medium may include any tangible, non-transitory storage media or memory media such as electronic, magnetic, or optical media—e.g., disk or CD/DVD-ROM coupled to computer system 300 via bus 306, or non-volatile memory storage (e.g., “flash” memory)

The terms “tangible” and “non-transitory,” as used herein, are intended to describe a computer-readable storage medium (or “memory”) excluding propagating electromagnetic signals, but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including for example, random access memory (RAM). Program instructions and data stored on a tangible computer-accessible storage medium in non-transitory form may further be transmitted by transmission media or signals such as electrical, electromagnetic, analog or digital signals, which may be conveyed via a communication medium such as a network and/or a wireless link.

In an embodiment, bus 306 may be configured to coordinate I/O traffic between processor 302, system memory 304, and any peripheral devices including network interface 308 or other peripheral interfaces, connected via I/O controller(s) 310. In some embodiments, bus 306 may perform any necessary protocol, timing or other data transformations to convert data signals from one component (e.g., system memory 304) into a format suitable for use by another component (e.g., processor(s) 302A-N). In some embodiments, bus 306 may include support for devices attached through various types of peripheral buses, such as a variant of the Peripheral Component Interconnect (PCI) bus standard or the Universal Serial Bus (USB) standard, for example. In some embodiments, the operations of bus 306 may be split into two or more separate components, such as a north bridge and a south bridge, for example. In addition, in some embodiments some or all of the operations of bus 306, such as an interface to system memory 304, may be incorporated directly into processor(s) 302A-N.

Network interface 308 may be configured to allow data to be exchanged between computer system 300 and other devices, such as other computer systems attached to application server 106, for example. In various embodiments, network interface 308 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

I/O controller(s) 310 may, in some embodiments, enable connection to one or more display terminals, keyboards, keypads, touch screens, scanning devices, voice or optical recognition devices, or any other devices suitable for entering or retrieving data by one or more computer system 300. Multiple input/output devices may be present in computer system 300 or may be distributed on various nodes of computer system 300. In some embodiments, similar I/O devices may be separate from computer system 300 and may interact with computer system 300 through a wired or wireless connection, such as over network interface 308.

As shown in FIG. 3, memory 304 may include program instructions 318, configured to implement certain embodiments described herein, and data storage 320, comprising various data accessible by program instructions 318. In an embodiment, program instructions 318 may include software elements of embodiments illustrated in FIGS. 6-11. For example, program instructions 318 may be implemented in various embodiments using any desired programming language, scripting language, or combination of programming languages and/or scripting languages. Data storage 320 may include data that may be used in these embodiments such as, for example, account information. In other embodiments, other or different software elements and data may be included.

A person of ordinary skill in the art will appreciate that computer system 300 is merely illustrative and is not intended to limit the scope of the disclosure described herein. In particular, the computer system and devices may include any combination of hardware or software that can perform the indicated operations. In addition, the operations performed by the illustrated components may, in some embodiments, be performed by fewer components or distributed across additional components. Similarly, in other embodiments, the operations of some of the illustrated components may not be performed and/or other additional operations may be available. Accordingly, systems and methods described herein may be implemented or executed with other computer system configurations.

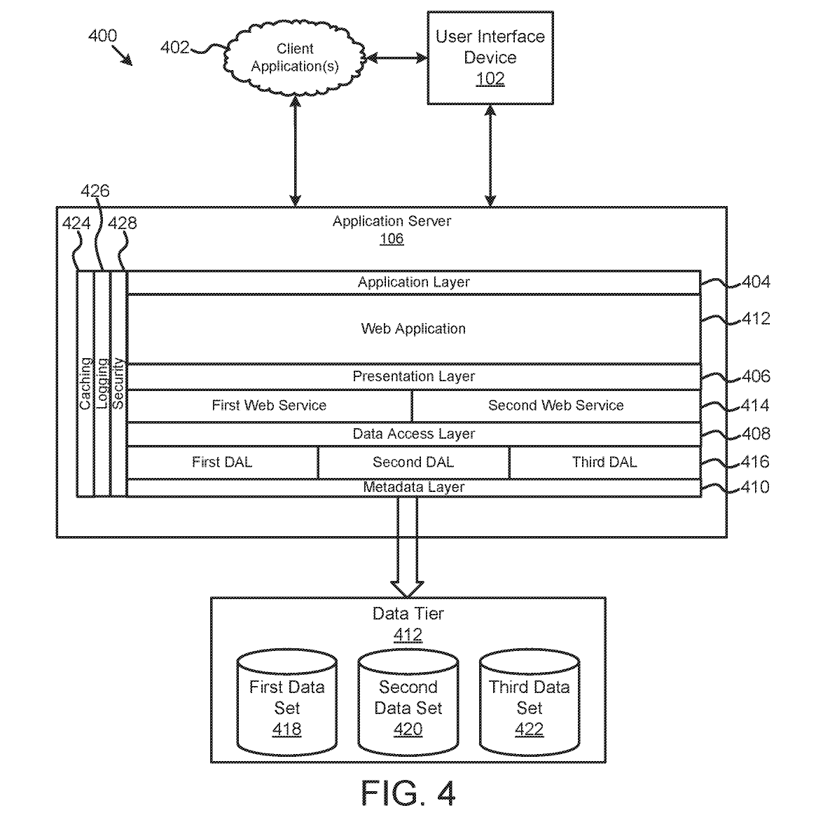

FIG. 4 is a schematic diagram illustrating an embodiment of a network architecture 400 for combined electronic payment and transfer for digital banking channels. In one embodiment, the network-based system 400 includes an application server 106. Additionally, the network-based system 400 may include a user interface device 102. In still a further embodiment, the network-based system 400 may include one or more network-based client applications 402 configured to be operated over a network 104 including the Internet, or the like. In still another embodiment, the network-based system 400 may include one or more data storage devices 108-110 configured to store data sets 418-422 in the data tier 412.

The network-based system 400 may include components or devices configured to operate in various network layers. For example, the application server 106 may include modules configured to work within an application layer 404, a presentation layer 406, a data access layer 408 and a metadata layer 410. In a further embodiment, the server 102 may access one or more data sets 422-422 that comprise a data layer or data tier 412. For example, a first data set 422, a second data set 420 and a third data set 422 may comprise a data tier 412 that is stored on one or more data storage devices 108-110.

One or more web applications 412 may operate in the application layer 404. For example, a user may interact with the web application 412 though one or more I/O interfaces 318, 320 configured to interface with the web application 412 through an I/O controller 310 that operates on the application layer 404. In one particular embodiment, a web application 412 may be provided for combined electronic payment and transfer for digital banking channels that includes software modules configured to perform the steps of the methods described in FIGS. 6-11.

In a further embodiment, the server 106 may include components, devices, hardware modules, or software modules configured to operate in the presentation layer 406 to support one or more web services 414. For example, a web application 412 may access or provide access to a web service 414 to perform one or more web-based functions for the web application 412. In one embodiment, a web application 412 may operate on the application server 106 and access one or more web services 414 hosted on a second server (e.g., account server 118a) during operation.

For example, a web application 412 for establishing account information records or initiating money transfer transactions, or other information may access a first web service 414 for setting up account records and a second web service 414 for initiating money transfers. The web services 414 may receive a command to initiate a money transfer. In response, the web service 414 may return data information about the transaction status or history. One of ordinary skill in the art will recognize various web-based architectures employing web services 414 for modular operation of a web application 412.

In one embodiment, a web application 412 or a web service 414 may access one or more of the data sets 418, 420, 422 through the data access layer 408. In certain embodiments, the data access layer 408 may be divided into one or more independent data access layers 416 for accessing individual data sets 418, 420, 422 in the data tier 412. These individual data access layers 416 may be referred to as data sockets or adapters. The data access layers 416 may utilize metadata from the metadata layer 410 to provide the web application 412 or the web service 414 with specific access to the data set 412.

For example, the data access layer 416 may include operations for performing a query of the data sets 418, 420, 422 to retrieve specific information for the web application 412 or the web service 414. In a more specific example, the data access layer 416 may include a query for transaction history from one or more of the transaction rails.

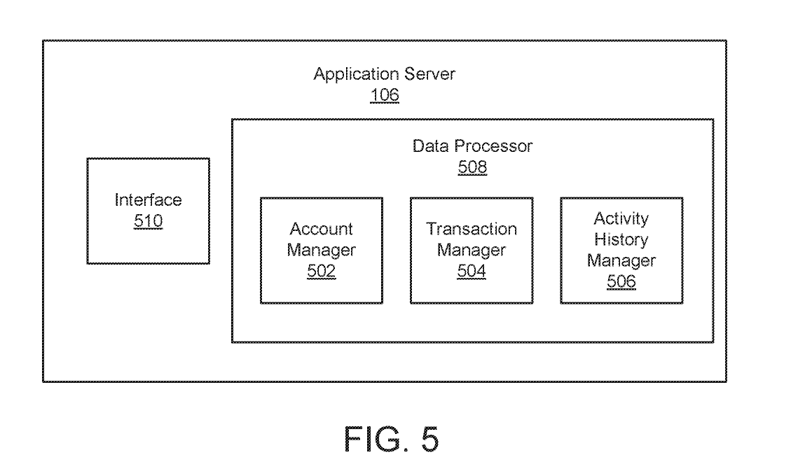

FIG. 5 is a schematic block diagram illustrating an embodiment of an apparatus for combined electronic payment and transfer for digital banking channels. In an embodiment, the apparatus comprises the application server 106. The server 106 may include a communication interface 510, such as the network interface 308. The application server 106 may also include a processor configured to execute software-defined modules for carrying out one or more operations of the methods described in FIGS. 6-11. In one embodiment, the modules may include an account manager 502, a transaction manager 504, and an activity history manager 506.

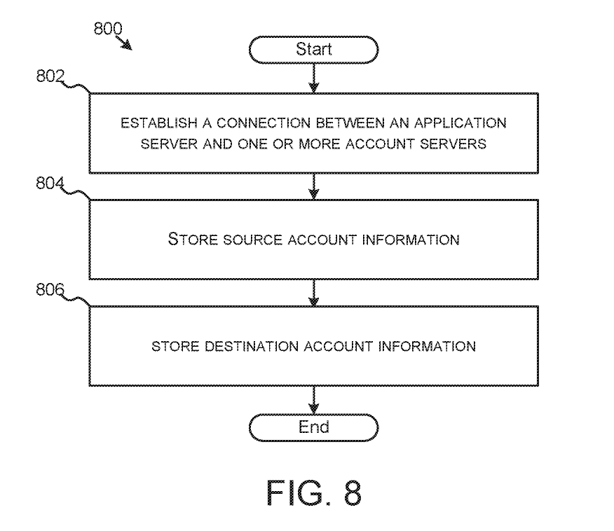

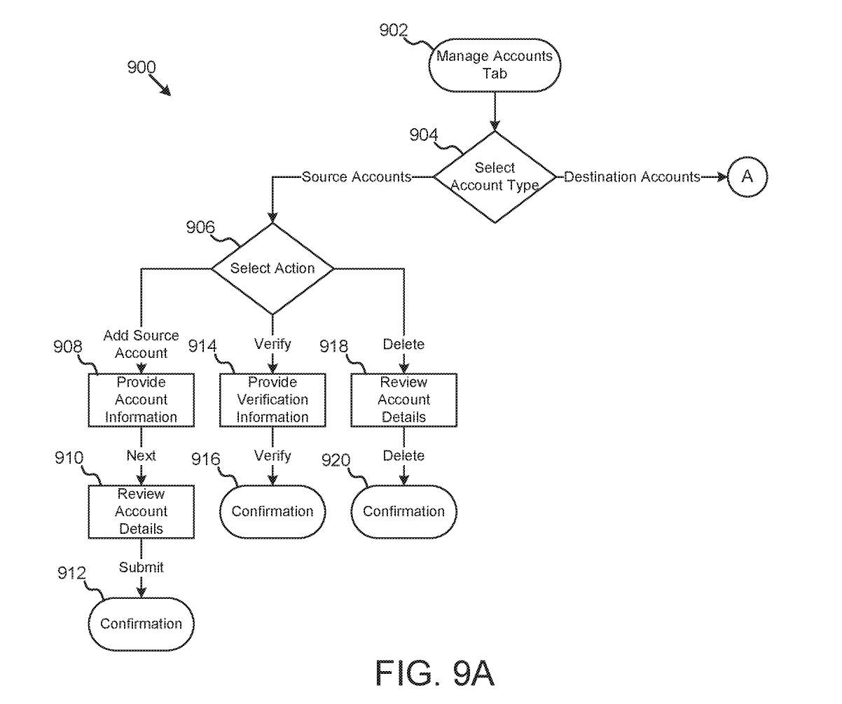

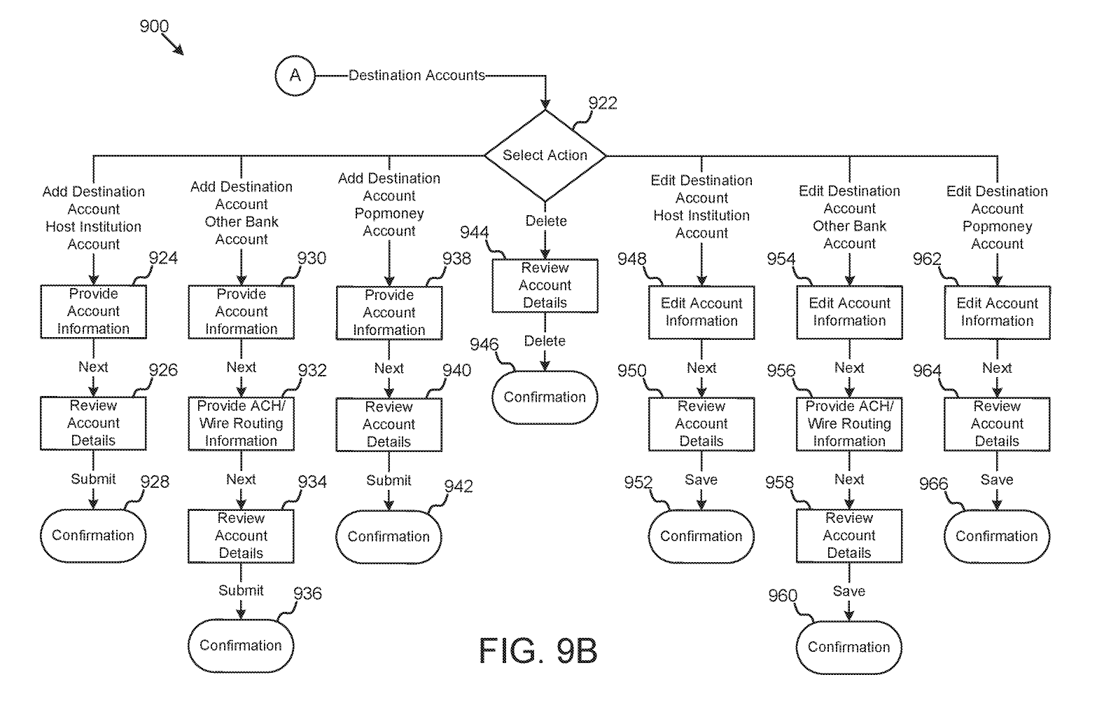

In an embodiment, the account manager 502 may be configured to handle account setup operations, such as the operations described in FIGS. 8-9B. In one embodiment, the application server 106 may establish a connection over communication interface 510 with one or more account servers 118a-c. Additionally, the account manager 502 may connect with the user interface 102 over the interface 510. The user may provide account information to the account manager 502 over communication interface 510. The account manager 502 may store a first information set associated with a source account on a consolidated account data storage device 108. The first information set may include information required to conduct a transaction over any one of a plurality of transaction rails. Additionally, the account manager 502 may store a second information set associated with a destination account on the consolidated account data storage device 108. The second information set may include information required to conduct a transaction with the source account over any one of the plurality of transaction rails 122-126.

In an embodiment, the transaction manager 504 may receive a selection of a source account for a transaction between a source account server (e.g., account server 118a) and a destination account server (e.g., account server 118c). The transaction manager 504 may also receive a selection of a destination account for a transaction between a source account server and a destination account server. The transaction manager 504 may further receive one or more transaction parameters for the transaction between the source account server and the destination account server.

In response to receiving the selections from the user interface device 102 over the communication interface 510, the transaction manager 504 may determine one or more transaction rails suitable for conducting the transaction in response to the transaction parameters. For example, the transaction manager 504 may reference a set of transaction rules. Examples of transaction rules may include rules involving prescribed transaction rails for certain transactions between institutions located in different countries, transactions involving money over a certain predetermined dollar limit, transactions to or from particular account types, and the like.

The transaction manager 504 may then generate one or more transaction characteristics for presentation to a user to further refine identification of the transaction rail. For example, transaction characteristics may include the amount of money to be transferred, a cost for the transaction, a timeframe for the transaction, etc. Prompts for the transaction characteristics may be displayed by the user interface device 102 to the user.

The user may then enter the transaction characteristics and communicate them back to the application server 106. The application server 106 may receive the one or more selected transaction characteristics from the user over the communication interface 510. The transaction manager 504 may then initiate the transaction between the source account server and the destination account server in response over a transaction rail determined in response to the selected transaction characteristics.

In an embodiment, the activity history manager 506 may establish a connection between an application server 106 and one or more transaction data storage devices, such as databases 202, 204, 206. In an embodiment, the activity manager 506 may obtain, over the communication interface 510, transaction data associated with a selected account from each of the transaction data storage devices 202, 204, 206. The data associated with the selected account stored at each of the transaction data storage devices 202, 204, 206 may include a record of a transaction performed over a specific transaction rail. Additionally, the activity history manager 506 may store, in a consolidated data storage device 110, the transaction data associated obtained from each of the transaction data storage devices in an aggregated data set associated with the selected account.

Although the described functions of the application code have been described as modules executed on the application server 106, with commands and information communicated back and forth with the user interface device 102, one of ordinary skill will recognize that one or more functions of the account manager 502, transaction manager 504, and activity history manager 506 may be carried out directly by the application running on the user interface device 102. Indeed, some or all of the described functions may be carried out by a program executed locally to the user interface device. In other embodiments, the described functions may be distributed across one or more other components of the system 100. It will be appreciated, that while the architectures of FIGS. 1-5 are embodiments of systems that may be suitable for carrying out the functions described in FIGS. 6-11, other suitable systems and architectures exist.

### Methods of Operation

FIG. 6 is a schematic flowchart diagram illustrating an embodiment of a method 600 for combined electronic payment and transfer for digital banking channels. In an embodiment, the method 600 starts with receiving a selection of a source account for a money transfer transaction, as shown at block 602. At block 604, the method 600 includes receiving a selection of a suitable destination account for the transaction given the selection of a previous source account. At block 606, the method 600 includes receiving one or more transaction parameters for a transaction. For example, the transaction parameters may include an account type, the institution hosting the account, etc. The method 600 may include determining one or more transaction rails suitable for the transaction at block 608. At block 610, the method 600 includes generating one or more transaction characteristic prompts for presentation to a user. At block 612, the method 600 includes receiving a selected transaction characteristic from a user. For example, the selected transaction characteristics may include a timeframe for the transaction, a cost for the transaction, and/or an amount for the transaction. At block 614, the method 600 includes scheduling or initiating the transaction over the transaction rail determined in response to the selected transaction characteristics.

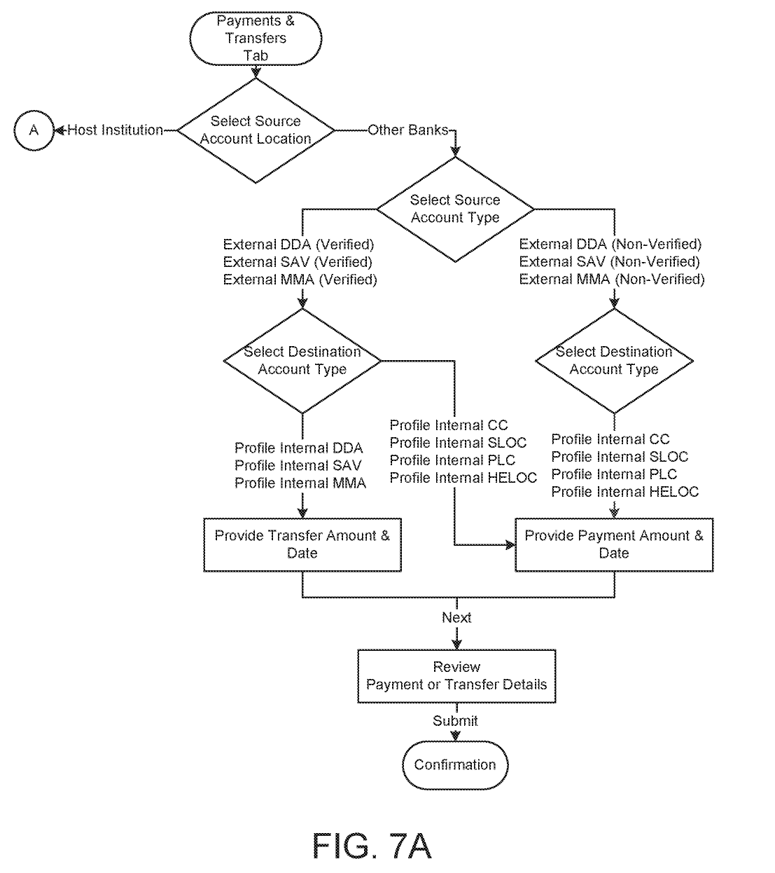

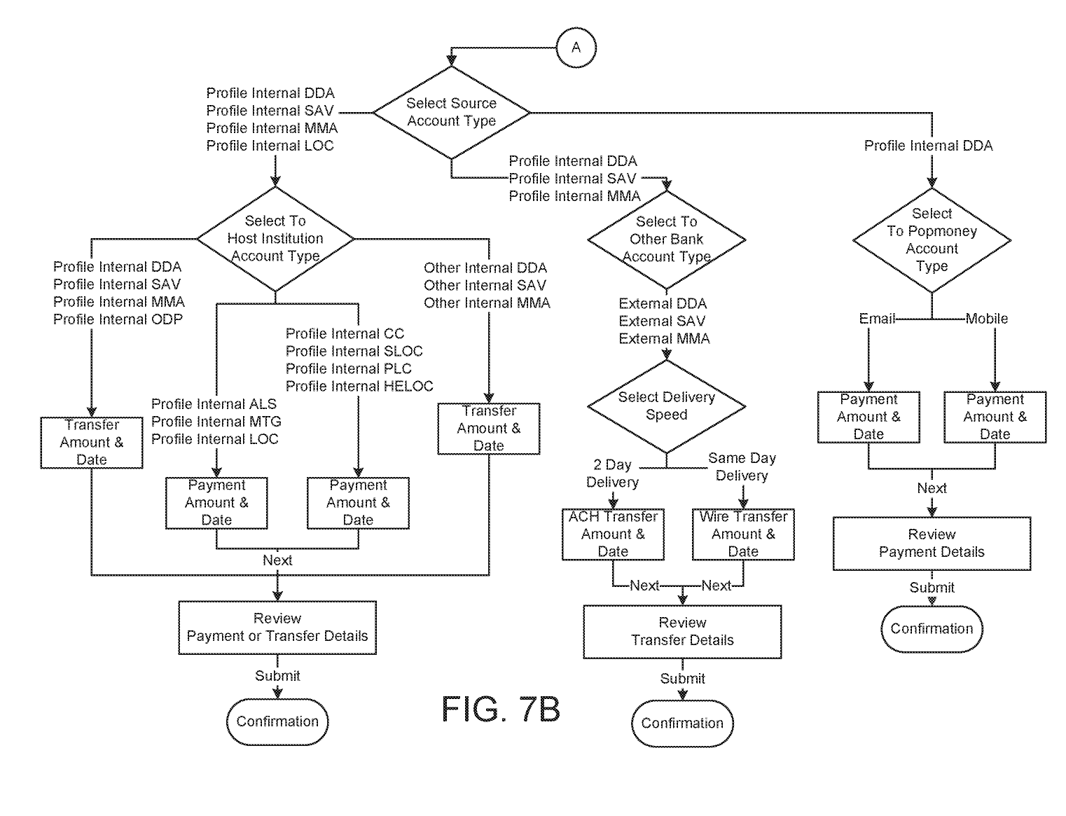

FIGS. 7A-7B illustrate a detailed method for managing a money transfer transaction. At FIG. 7A, the method 700 starts when a user lands at a “Payments & Transfers” tab of a payments and transfers application. At block 704, the source account location is selected. The options include the host institution (e.g., the institution hosting and managing the application server 106) and other banks. If the user selects an account at the host institution, then the method progresses to the flow of FIG. 7B as indicated by off-page reference (A). Otherwise, the source account type is selected at block 706. The destination account type is selected at block 708 if the source account is an external verified account, or at block 710 if the source account is an external non-verified account. If the destination account type is a Direct Deposit Account (DDA), a savings account (SAV), or a Money Market Account (MMA) that is listed on the user's internal profile, or dashboard list of managed accounts, then direct money transfer can occur, and the user is prompted to provide transfer characteristics, such as the transfer amount and date at block 712.

On a banking application, a user is typically provided with a home landing page or dashboard page that includes the users “profile accounts,” or accounts that the user has elected to directly manage through the dashboard of the banking application. Therefore, in the flowcharts of FIGS. 7A-B, accounts designated as “profile internal” are accounts listed on the user's home profile of managed accounts, whereas accounts designated as “profile external” are hosted by a secondary financial institution and displayed on the user's home profile of accounts.

If the account type is not DDA, SAV, or MMA, then it is automatically determined that the money must be transferred as a payment to a credit account because a predetermined set of rules or policies that specify certain transaction types suitable for use with certain external account types.

If the account type is Credit Card (CC), Signature Line of Credit (SLOC), Personal Line of Credit (PLOC), or Home Equity Line of Credit (HELOC), then the user is prompted to provide payment characteristics, such as the payment amount and date at block 714. At block 716 the money transaction details are reviewed and the user initiates the transaction by selecting “Submit.” Upon completion of the transaction order, a confirmation is provided at block 718.

If the selected source account is located at the Host institution, then the flow progresses as shown in FIG. 7B from off-page reference (A) on FIG. 7A. At block 720, the source account type is selected. At blocks 722, 724, 726, the destination account type is selected. If the account type is internal to the Host institution, the flow progresses at block 722. If the destination account is at another banking institution, then the flow progresses at block 724. If the selected destination account is a popmoney account, then the flow progresses at block 726.

At block 722, the host institution Account type is determined for the destination account. For example, if the account is “Profile Internal” (e.g., on the user's list of managed accounts), and also a DDA, SAV, MMA, or ODP account, then the user is prompted for the transfer amount and data at block. Similarly, if the account is a DDA, SAV, or MMA account that is not on the user's profile, but is still internal to the institution, then the user is prompted for the transfer amount and date information at block 730. Otherwise, the transaction is classified as a payment, and the user is prompted for payment amount and data information at blocks 732-734, depending upon the destination account type. The transaction details are reviewed at block 736 and the transfer confirmation details are provided at block 738.

If, at block 724, it is determined that the destination account is located at another banking institution, and the account is a DDA, SAV, or MMA account, then the user may be prompted for the required delivery speed at block 740. If a longer delivery time is selected, then the user is prompted for the amount and date associated with an ACH transfer at block 742. If same-day delivery is required, then the user is prompted for the amount and date that a wire transfer is to be transacted at block 744. The user reviews the transfer details at block 746, and the confirmation details are provided at block 748.

If, at block 726, it is determined that the destination account is a popmoney account type, then the user is prompted to provide the payment amount and data, either by email at block 750, or by mobile text at block 752. The user then reviews the payment details 754 and confirmation details are presented at block 756.

FIG. 8 is a schematic flowchart diagram illustrating an embodiment of a method 800 for combined electronic payment and transfer for digital banking channels. In an embodiment, the method 800 includes establishing a connection between an application server 106 and one or more account servers 118a-c, as shown at block 802. At block 804, the method 800 includes storing source account information, including information required to conduct a transaction over a plurality of rails. For example, the source account information may include sufficient information for allowing the user to conduct a money transfer transaction using one or more of a plurality of transaction rails. At block 806, the user stores similar destination account information, including information required to conduct a transaction over a plurality of rails.

The embodiments of FIGS. 9A-9B illustrate further detail of the account setup process 900. At FIG. 9A, the user lands on the “Manage Accounts” tab at block 902. At block 904, the account type is selected 904 for management. If the account is a source account, then an action is selected at block 906. If the action is to add a new source account, then the user may be provided with prompts to provide account setup information at block 908, review the account details at block 910, and confirm account setup at block 912. If the action is to verify an account, then the user may be prompted to provide verification information at block 914. The system may automatically verify the account in response to the verification information provided, and provide a confirmation at block 916. If the action is to delete an account, then the user may review account details at block 918, select an account to be deleted, and confirm that the account was deleted at block 920.

If destination accounts was selected at block 904, then the flow may progress as illustrated in FIG. 9B from off-page reference (A) in FIG. 9A. At block 922 an action is selected. If the action is to add a destination account at the Host institution, then the user may be prompted to provide account information at block 924, review the provided account details at block 926, and receive a confirmation that the account has been set up at block 928. In such an embodiment, the user may be prompted to provide all information necessary to conduct money transfer operations over multiple money transfer rails.

If the action is to add a destination account at another banking institution, the user may be prompted to provide the account information 930, provide ACH or Wire Routing information at block 932, review account information at block 934, and review the confirmation at block 936.

If the action is to add a popmoney destination account, then the user may be prompted to provide account information, including popmoney details at block 938, review at block 940, and receive confirmation at block 942.

If the action is to delete a destination account, the user may be prompted to review account details at block 944 and receive confirmation at block 946. The user may also select editing actions on each of the previously established account types, as shown in blocks 948-966, respectively.

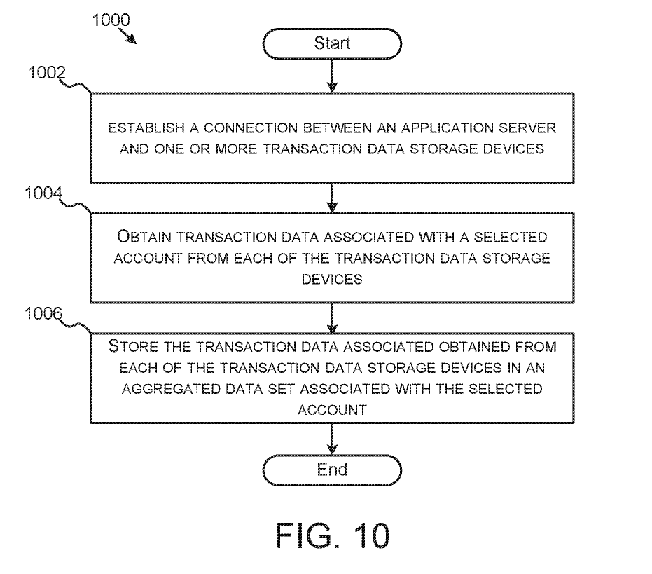

FIG. 10 illustrates a method 1000 of providing a consolidated transaction history. In an embodiment, the method 1000 starts at block 1002 with establishing a connection between an application server 106 and one or more transaction data storage devices 202, 204, 206. At block 1004, the method 1000 includes obtaining transaction data associated with a selected banking profile from each of the transaction data storage devices 202, 204, 206. The method 1000 may also include storing the transaction data obtained from each of the transaction data storage devices in an aggregated data set associated with the selected banking profile, as shown at block 1006.

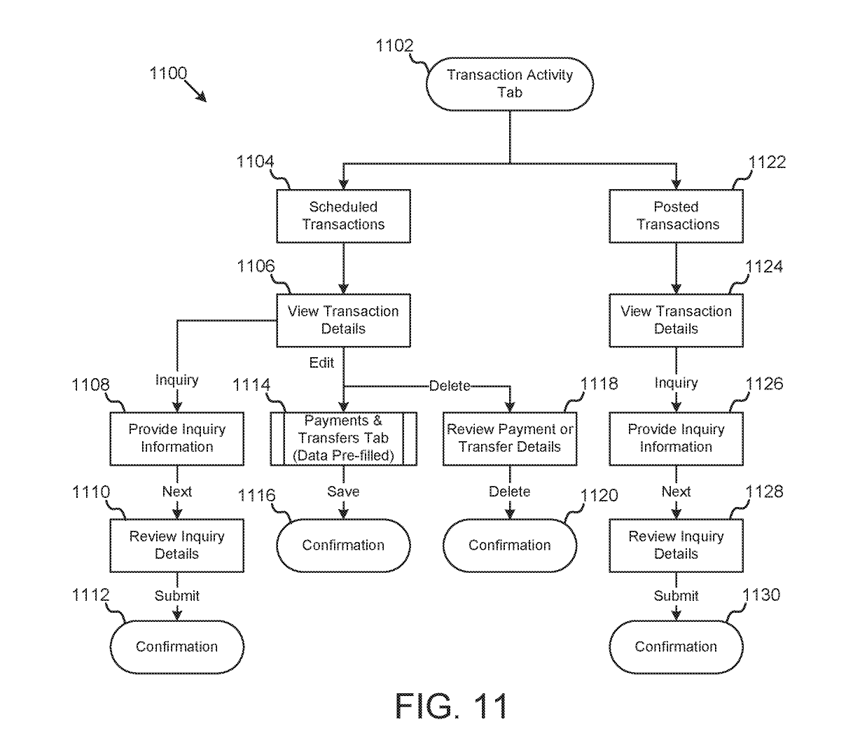

FIG. 11 illustrates a further embodiment of account history consolidation. In an embodiment, the method 1100 starts when a user lands at the transaction activity tab at block 1102. The user may view scheduled transactions at block 1104 or posted transactions at block 1122. If the user selects scheduled transactions, the user may view transaction details at block 1106. The user may then further perform an inquiry by providing inquiry information at block 1108, review the returned inquiry results 1110 and receive a confirmation at block 1112. The user may additionally edit transaction details as described at block 1114, which is further defined in FIGS. 7A-7B, and receive confirmation at block 1116. Alternatively, the user may delete payment or payment details at blocks 1118 and 1120.

If the user selects posted transactions 1122, then the user may view transaction details 1124, providing inquiry information at block 1126, review inquiry details at block 1128, and review confirmations 1130, for all posted transactions.

### EXAMPLES

### Easy Payment Processing System

Unlike the prior art, the Easy Payments and Transfers (EPT) system of the present disclosure comprises a single master file of source and destination accounts where each record contains single identifying information related to the account, such as, but not limited to, the account holder's name, depository institution's name, and additionally, all the identifying information related to the multiple payment methods for that specific account and/or recipient, such as, but not limited to, Wire Routing Number, ACH Routing Number, email address of recipient, mobile number, social media handle, etc. This single master file may be implemented as a real or as a virtual database. A real database would contain all the records stored in a unique, individual database, independently of the various payment methods and would be the ultimate system of record for storing the destination accounts or payees. This master file can also be implemented as a virtual database, where the system of record for each payment type will still be each of the individual databases directly related to a particular payment method, but the multiple records dispersed across multiple databases will be combined in a single virtual record, with a single unified and consistent identifying information and the particular identifying field for each payment method.

Due to this particular database structure and organization or records, it is not necessary to select a particular payment method a priori or with prior knowledge of the intended payment method. Instead, the user simply selects first the account from which the funds would be withdrawn, and then the destination account where the funds would be deposited. This system can be utilized in any digital banking channel, such as but not limited to Mobile Banking, Online Banking, Automatic Teller Machines (ATM), and Interactive Voice Response (IVR). While software and computer systems for these different channels are widely available, the processes, systems, and methods described for the disclosed EPT system and method requires modification of various software components in both the front end and back end of the EPT system consistent with the disclosure presented herein.

Because each account record in the single master file contains all the required information in order to identify that particular account in the system of record of that particular payment method, the user is able to determine indirectly how the money would be moved, not by selecting a method of payment as in the prior art, but by selecting the particular attributes of each option, such as, but not limited to, delivery speed, transaction cost, allowed transaction limits, etc. For this reason, the user is not required to select one of multiple links pointing to the various electronic payments and transfers methods, but instead, the user selects a single option in order to execute all of the possible money movement transactions.

The disclosed system eliminates any potential issues with different software solutions from different vendors for different payment methods and the related incompatibility of data problems between these different solutions. For example, in the prior art, each separate system is accessed independently from a unique link, whereas in the disclosed embodiment, all of the individual systems communicate to this single process via web services or thru any other open data exchange format, and all the systems share their data in their own way, with the common factor being the EPT system of the disclosed embodiment which becomes the universal link between all independent systems. As described in the next section, when EPT is implemented as a virtual database, all the records are read from each of the systems and the data is merged into a single master file containing all the payment data from the different independent systems.

### Data Model

In the prior art, there is a dependency between the data and the payment method, as the records pertaining to a transaction type (e.g., Wire, ACH, P2P, A2A, etc.) are contained in separate databases which link accounts with a particular type of routing indicator for the specific payment method involved, with no cross-reference between databases. The present disclosure solves this problem by utilizing a data model that consolidates all different records contained in one or multiple databases into a single master file, either by hosting all the data in a single database, or by merging data from multiple databases and consolidating it into a virtual single master file. Each record of the master file contains the unique identifying ownership information for the account (e.g., account holder's name, address, etc.) as well as all the corresponding routing or identifying codes for each of the payment methods offered. If the records for each individual payment method are hosted by multiple and different databases, a unique identifier such as account ID, bank ID, sequential numbered ID, etc., is used to link the different records pertaining to the same account across all databases. For example, the same account identifier (account number, nickname, etc.)/bank-name pair could identify all the records in the ACH, Wires, and P2P payees list to identify each appropriate routing number for all methods pertaining to such account. In order to generate and maintain the consistency across all records and databases when more than one is used, the data entry process used is the same as if all the data were to be contained in a single database or single master file.

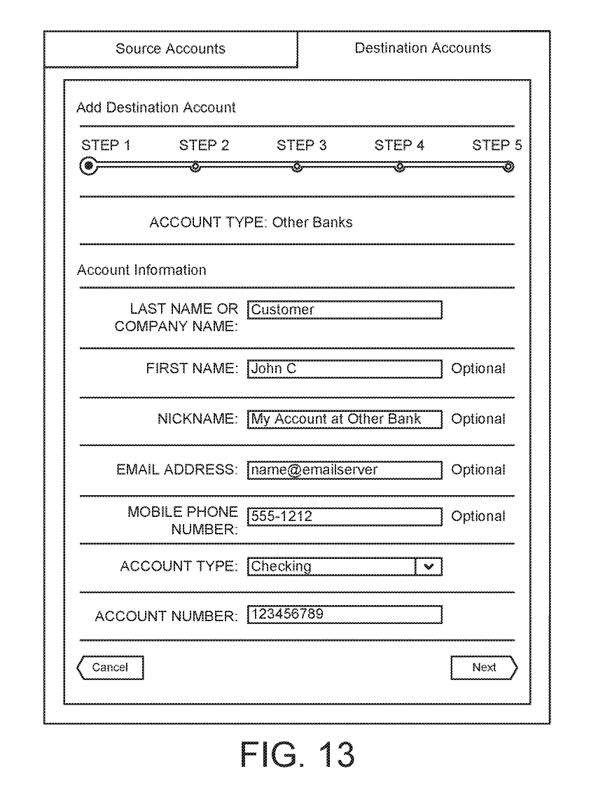

To create a new record, the single shared identifying information is entered only once on a digital form (see FIG. 13 as an example of the embodiment of the record capture process for the account identification fields), via an electronic channel (like Mobile Banking, Online Banking, ATM, etc.) to capture the data into a single database, which becomes the single master file of source or destination accounts, while the multiple routing or identifying numbers for each of the payment methods offered are entered individually. In this embodiment, the common information identifying the account is shared among all the databases for each payment method, while only the corresponding routing indicator for that particular method is stored at each database when more than one database is used. When only a single database is used, a single record is generated containing all the account information along with the different routing and identifying codes.

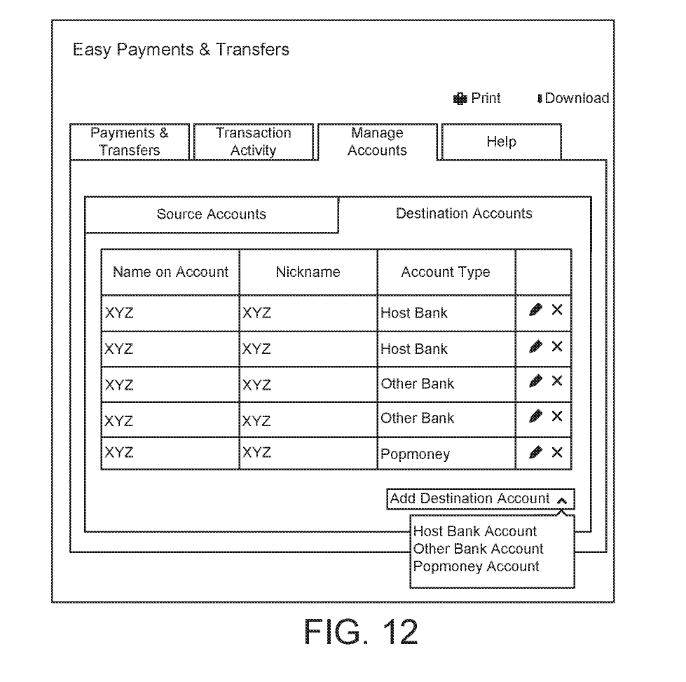

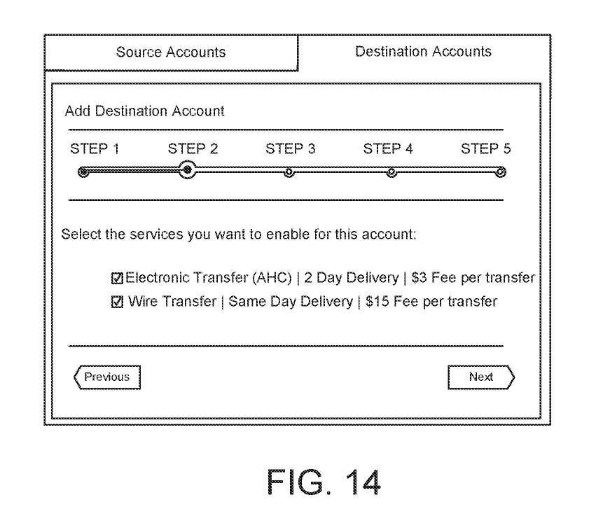

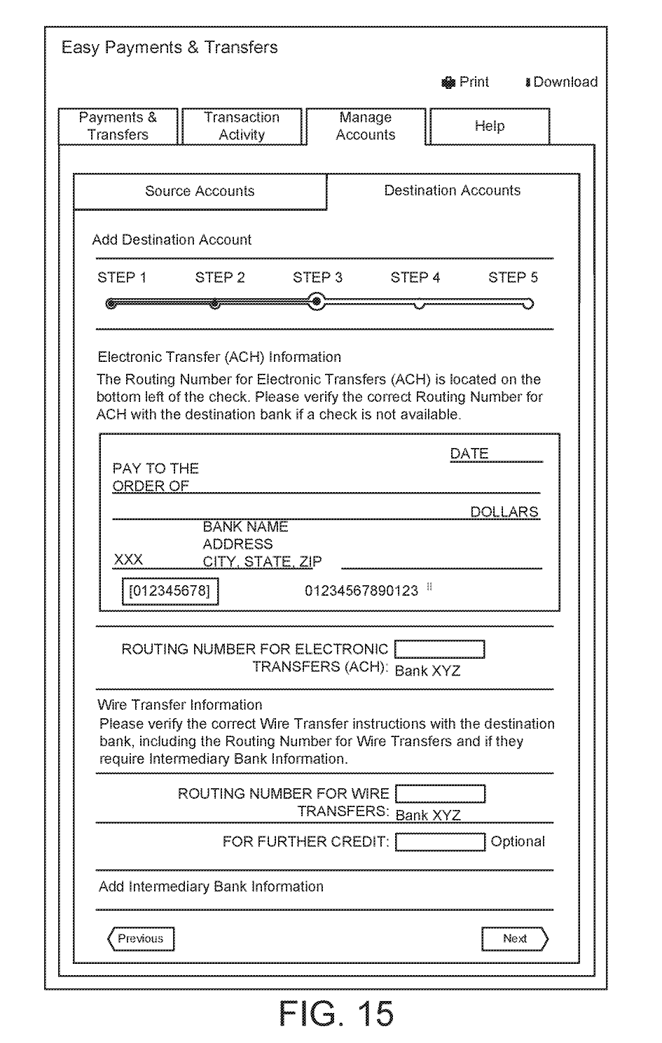

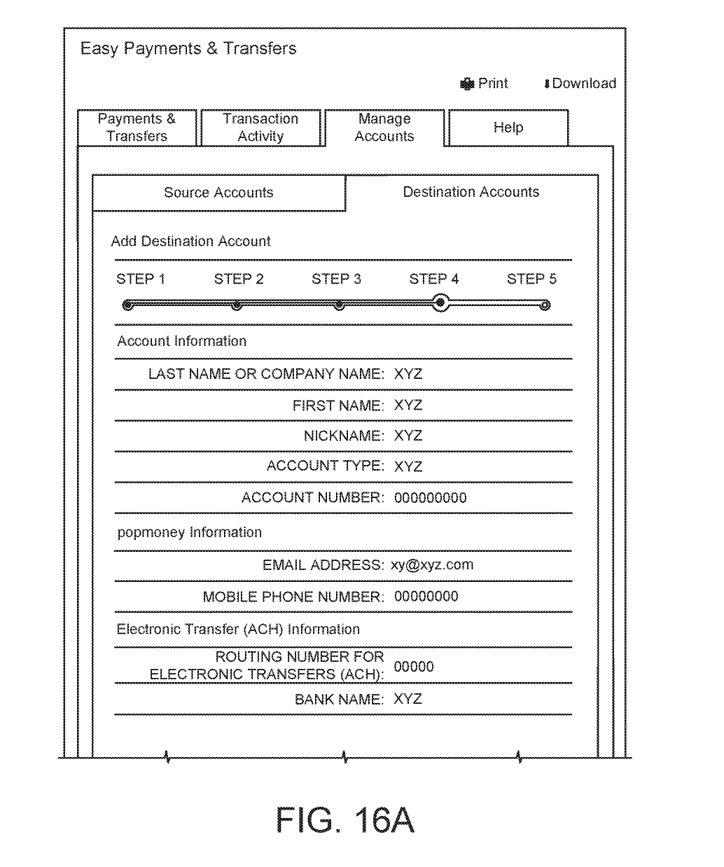

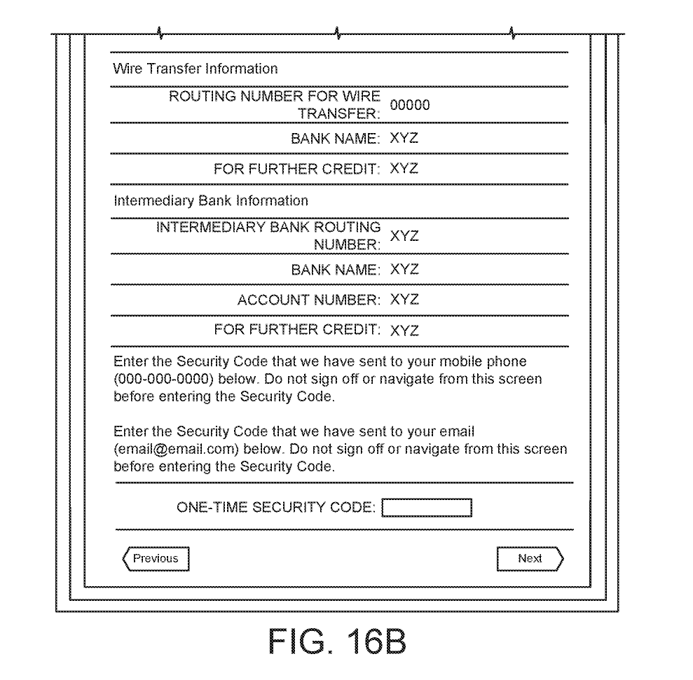

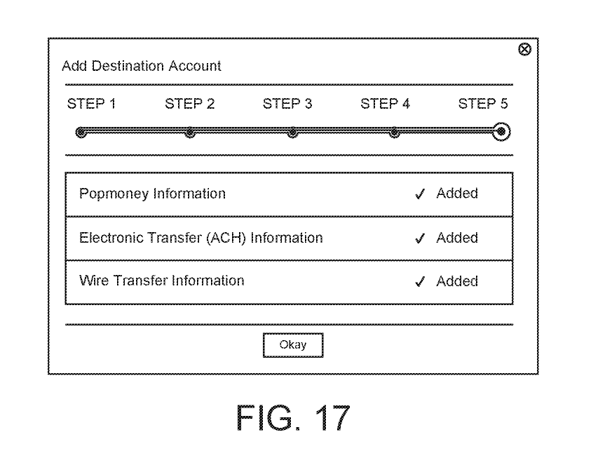

FIG. 12 illustrates various previously added destination accounts for a particular user for all money movement services. As described above, the inputted source and destination accounts are stored in a single database with the appropriate identifying information per account. A user has the option to add source or destination accounts to the user's profile in the money management system. FIGS. 13-17 illustrate exemplary steps taken by a user and displayed by a money payment and/or management system for inputting destination accounts. FIG. 13 illustrates a first step of adding a destination account to the money management system. As shown, data may be inputted by a user for a particular account, including the owner's name, nickname, account type, and account number. The inputted information will be used as shared common information for all potential transactions and payment methods within the money management system. The destination account can be internal or external to the financial institution. FIG. 14 illustrates a second step of enabling types of payment methods for a particular account, such as ACH transfer and Wire transfer. FIG. 15 illustrates a third step of inputting multiple routing numbers for different payment methods, such as ACH transfer and Wire transfer. In some embodiments, images of checks can be inputted and scanned by the system to capture and/or determine the appropriate routing number, or shown as an example to illustrate to the user where to find such information to be entered manually. FIGS. 16A-16B illustrates a fourth step in which confirmation is requested by a user for the previously inputted information, along with certain payment method identifiers, such as for ACH, Wire, and Popmoney (P2P) transfers. FIG. 17 illustrates a fifth step in which the system confirms the various payment methods added for a specific destination account.

A similar process can be performed to add a source account to the user's profile. The source account can be internal or external to the financial institution. In the case of external source accounts, an additional step may be required to validate the ownership of the account and prevent unauthorized withdrawals from said account by anyone other than the legal owner. The type of ownership validation performed to the account can be done by any standard process, such as micro-deposits, entering the holder bank's online credentials, and other similar methods.

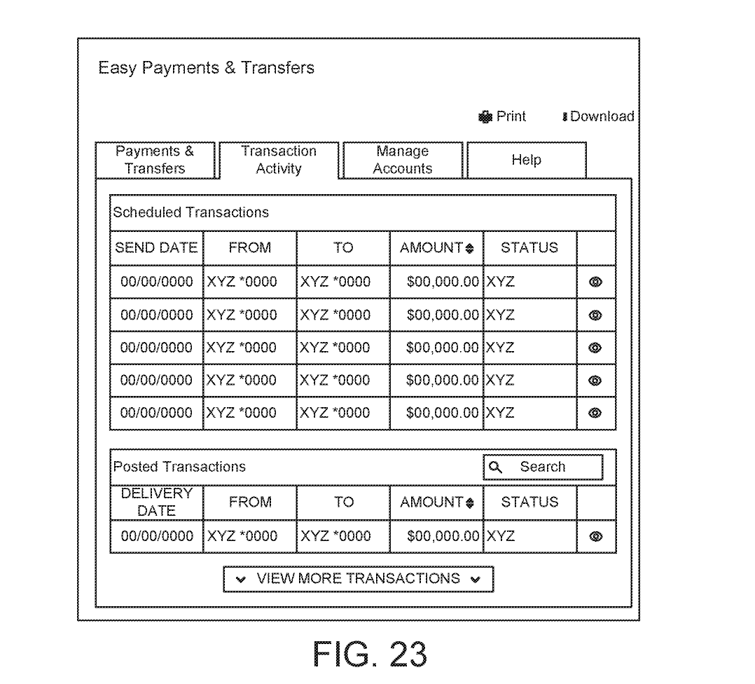

FIG. 23 illustrates an example of transaction activity for all money transactions previously performed for a particular user. In one embodiment, all types of different transactions across all accounts are displayed, which as described above has been unavailable in current money movement services and systems. Thus, the described money management system, by collecting, storing, and providing certain account data and information and transactions in a novel manner provides a single list of transactions across all transfers and payments, regardless of the payment method used. For each transaction, the Send date, From account, To account, Amount, and Status of the payment is displayed to identify said transactions. By having all the multiple and different transaction types displayed in a single location, it is easier than in the prior art to locate a specific transaction for the purpose of research, confirmation, cancellation, or any other purpose.

### Easy Payment Processing Procedure

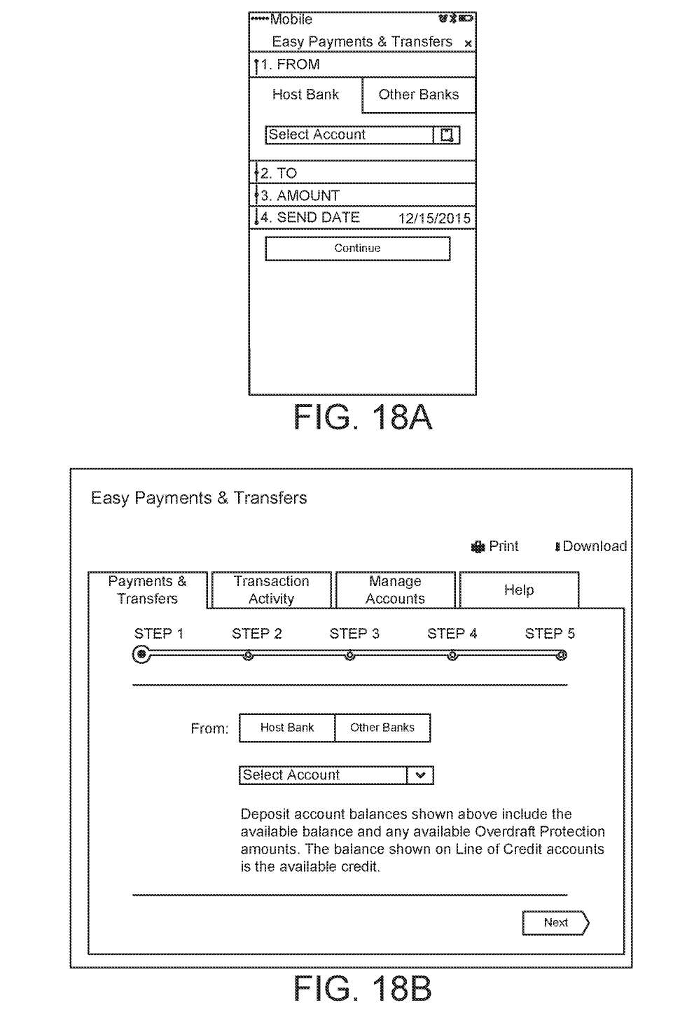

In one embodiment, the user is presented with a single menu option to access all money movement services. As shown in FIGS. 18A (mobile banking app) and 18B (online banking), the user starts the electronic payment or transfer process by selecting the origin or source account, also referred to as the “From” account, which could be an internal account (an account located at the bank initiating the transaction) or an external account (located at a different bank). This new selection process requires new back-end operations and/or underlying database configurations, including having all the account identifying information hosted in a single real or virtual master file.

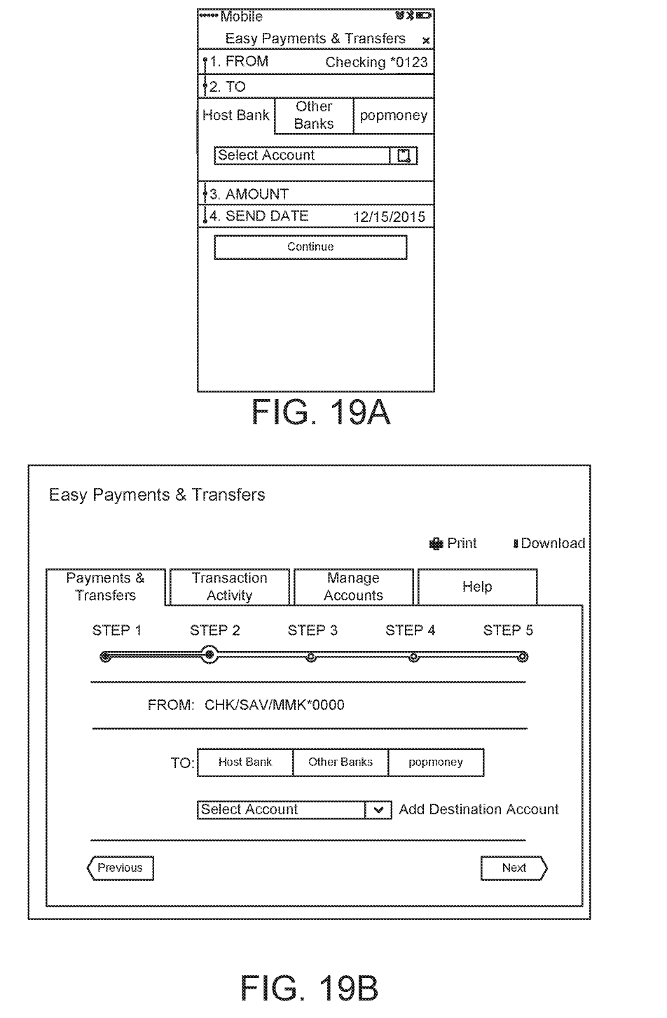

After the selection of the “From” account in the first step, the processing system intrinsically determines the available options to the user within the selection of destination account, also referred to as the “To” account, based on the services available at the financial institution performing the transaction. For example, if the “From” account is an external account hosted at another bank, the financial institution originating the transaction may not allow the money movement to yet another external account, as this may have a risk for money laundering, therefore limiting the available options to only internal accounts. As shown in FIGS. 19A (mobile banking app) and 19B (online banking), the user is presented with a list of available “To” account options within the system's constraints.

Once a particular account is selected as a “To” account, if more than one set of identifiers (such as routing numbers for different payment methods, e.g., Wire, ACH, etc.) is available, the user will see the differentiating characteristics of each of the alternative methods in order to determine the most suitable option for performing the transaction. For example, if an account record contains routing numbers for both ACH and Wire transfers, the user will see the key differences such as delivery speed and processing fees for each alternative method. The characteristics for each transaction type are hosted on a reference file. For example, an ACH transfer may require 1-3 days for delivery and include a $3 fee, while a Wire transfer may allow same day delivery for a $15 fee. Thus, the user can select the desired payment route without necessarily having to know the underlying method utilized to perform the transaction. This step, and in particular the selected From/To account pairing, allows the processing system to automatically determine without user intervention the payment rails or methods that the financial institution will use to perform the intended transaction. This From/To account pairing is a critical element of the overall process, as the account selections, and therefore the subsequent processes to move the money, will determine not only the amount options but also the limits, if any are tied to any particular payment method that would be used to perform the transaction based on the risk assessment of each rail.

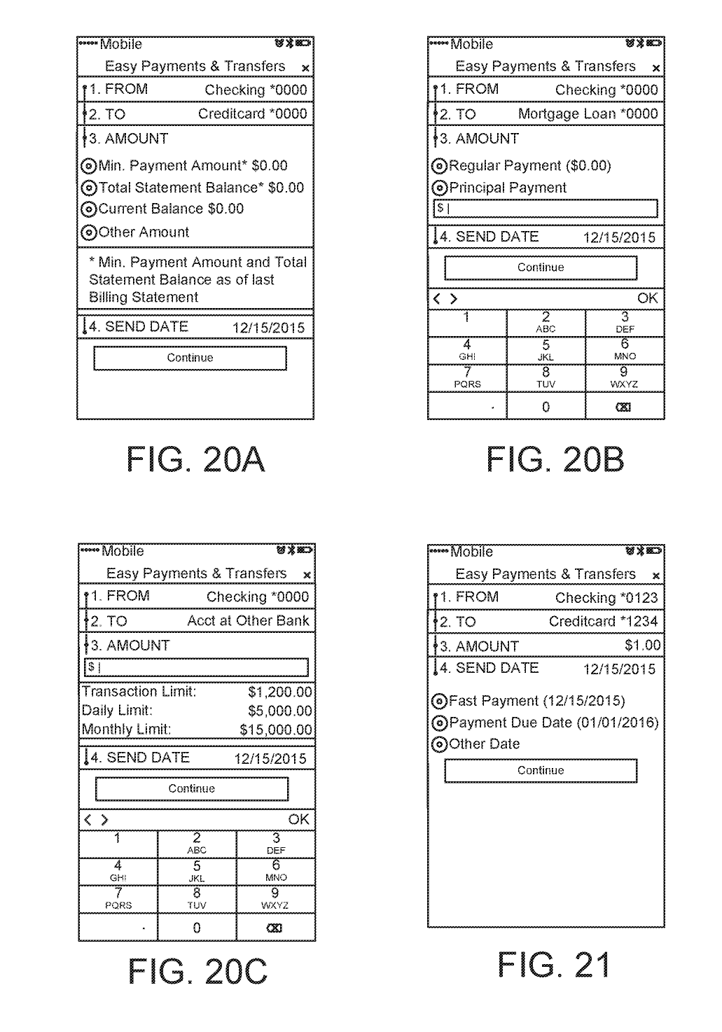

Having selected the origin and destination accounts, the user simply needs to define the amount of the transaction. As shown in FIGS. 20A (credit card payment), 20B (mortgage payment), and 20C (ACH transfer), the system automatically selects the appropriate amount options based on the “From” account and “To” account selections. Various amount options are presented to the user based on the selected From/To accounts. For example, a minimum payment, statement balance, or current balance may be presented for a credit card payment (FIG. 20A), while a regular payment, principal payment, or other payment may be presented as options for a mortgage payment (FIG. 20B).

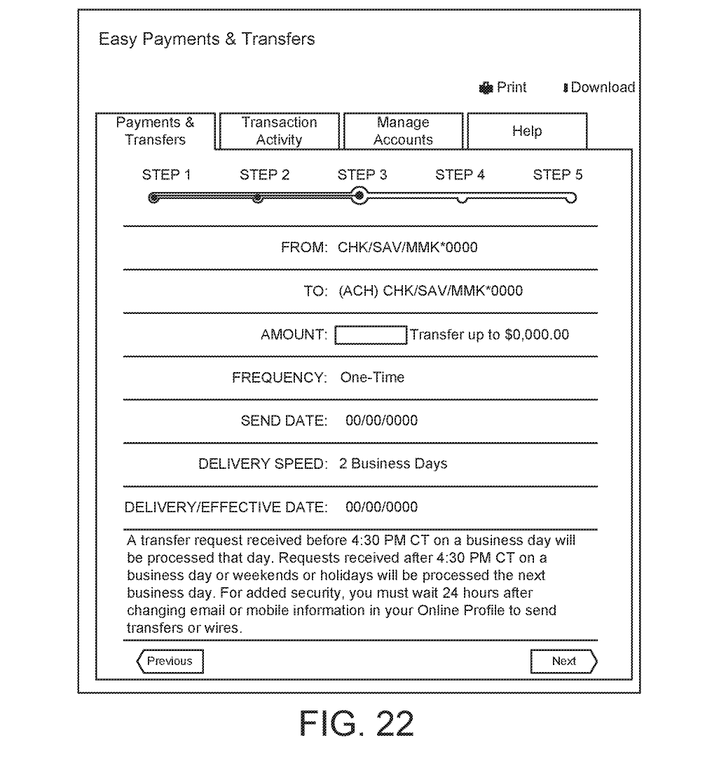

Finally, as shown in FIG. 21 (credit card payment) and FIGS. 22 (ACH transfer) the user selects the date when the transaction will originate. This date can be either the present day or any date in the future, as well as in a single transaction or as a part of a recurring transaction. Once again, various Send Date options are presented to the user based on the selected From/To accounts. For example, after a certain time of day (e.g., 5 PM or later), some transaction types may not be able to be processed that same day if their cut-off time has passed, and the earliest available date would be pre-selected for the user. Since each payment method may have different cut-off times, the transfer date options available change accordingly based on the previous From/To account pairs.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. A method, comprising:
receiving, over a communication interface to a remote user interface device, a selection of a source account for a money movement transaction between a source account server and a destination account server;
receiving, over the communication interface to the remote user interface device, a selection of a destination account for a transaction between a source account server and a destination account server;
receiving, over a communication interface, one or more transaction parameters for the transaction between the source account server and the destination account server;
determining, using a processing device, one or more transaction rails suitable for conducting the transaction in response to the transaction parameters;
generating, using a processing device, one or more transaction characteristics for presentation to a user;
receiving one or more selected transaction characteristics from the user; and
scheduling the transaction between the source account server and the destination account server over a transaction rail determined in response to the selected transaction characteristics.

2. The method of claim 1, further comprising generating an information prompt configured to request the transaction parameters.

3. The method of claim 1, wherein generating selectable options for the transaction rail is performed in response to at least one of the source account type, a time limit for completing the transaction, and a cost for completing the transaction.

4. The method of claim 1, wherein the transaction rails are selected from a group consisting of Automated Clearing House (ACH) transfer, direct debit, electronic check, wire transfer, credit transfer, and person-to-person payments service (P2P) transfer.

5. The method of claim 1, further comprising:
establishing a connection between an application server and one or more account servers;
storing a first information set associated with a source account on a consolidated account data storage device, the first information set containing information required to conduct a transaction over any one of a plurality of transaction rails;
storing a second information set associated a destination account on the consolidated account data storage device, the second information set containing information required to conduct a transaction with the source account over any one of the plurality of transaction rails.

6. The method of claim 5, wherein establishing the connection further comprises establishing a connection between the application server and an account server internal to an institution hosting the application server.

7. The method of claim 5, wherein establishing the connection further comprises establishing a connection between the application server and an account server external to an institution hosting the application server.

8. The method of claim 5, further comprising verifying authorization to establish a secure connection between the application server and the one or more account servers.

9. The method of claim 5, wherein storing the first information set further comprises generating a prompt for a user to input the information required to conduct a transaction over any one of the plurality of transaction rails.

10. The method of claim 5, wherein storing the second information set further comprises generating a prompt for a user to input the information required to conduct a transaction with a source account over any one of the plurality of transaction rails.

11. The method of claim 5, further comprising automatically copying an account record in the first information data set to the second information dataset, thereby automatically designating all source accounts as a destination account.

12. The method of claim 1, further comprising:
establishing a connection between an application server and one or more transaction data storage devices;
obtaining, over a communication interface, transaction data associated with a selected banking profile from each of the transaction data storage devices, wherein the data associated with the selected banking profile stored at each of the transaction data storage devices includes a record of a transaction performed over a specific transaction rail; and
storing, in a consolidated data storage device, the transaction data obtained from each of the transaction data storage devices in an aggregated data set associated with all the accounts of the selected banking profile.

13. The method of claim 12, further comprising retrieving the aggregated data set from the consolidated data storage device in response to a received request for transaction history information.

14. The method of claim 13, further comprising communicating the aggregated data set to a remote user interface device over a communication interface in response to receiving the request for the transaction history information.

15. The method of claim 1, wherein the transaction rails comprises any rails available to the financial institution.

16. An apparatus comprising:
a communication interface coupled to a remote user interface device, the communication interface configured to:
receive a selection of a source account for a money movement transaction between a source account server and a destination account server;
receive a selection of a destination account for a transaction between a source account server and a destination account server;
receive one or more transaction parameters for the transaction between the source account server and the destination account server; and
a processing device coupled to the communication interface, the processing device configured to:
determine one or more transaction rails suitable for conducting the transaction in response to the transaction parameters;
generate one or more transaction characteristics for presentation to a user;
receive one or more selected transaction characteristics from the user; and
schedule the transaction between the source account server and the destination account server over a transaction rail determined in response to the selected transaction characteristics.

17. The apparatus of claim 16, wherein the data processor is further configured to generate an information prompt configured to request the transaction parameters.

18. The apparatus of claim 16, wherein generating selectable options for the transaction rail is performed in response to at least one of the source account type, a time limit for completing the transaction, and a cost for completing the transaction.

19. A system, comprising:
a user interface device configured to operate a banking and payments application; and
an application server in communication with the user interface device, the application server comprising:
a communication interface coupled to a remote user interface device, the communication interface configured to:
receive a selection of a source account for a money movement transaction between a source account server and a destination account server;
receive a selection of a destination account for a transaction between a source account server and a destination account server;
receive one or more transaction parameters for the transaction between the source account server and the destination account server; and
a processing device coupled to the communication interface, the processing device configured to:
determine one or more transaction rails suitable for conducting the transaction in response to the transaction parameters;
generate one or more transaction characteristics for presentation to a user;
receive one or more selected transaction characteristics from the user; and
schedule the transaction between the source account server and the destination account server over a transaction rail determined in response to the selected transaction characteristics.

20. The system of claim 19, further comprising a consolidated account data storage device configured to store information sets associated with source accounts for a transaction and destination accounts for a transaction, the information sets containing information required to conduct a transaction over any one of a plurality of transaction rails

21. The system of claim 19, wherein the application server is further configured to:
establish a connection with one or more account servers;
store a first information set associated with a source account on a consolidated account data storage device, the first information set containing information required to conduct a transaction over any one of a plurality of transaction rails;
store a second information set associated with a destination account on the consolidated account data storage device, the second information set containing information required to conduct a transaction with the source account over any one of the plurality of transaction rails.

22. The system of claim 19, further comprising a consolidated data storage device configured to store transaction history information, associated with accounts from a selected banking profile, from a plurality of transaction rails.

23. The system of claim 22, wherein the application server is further configured to:
establish a connection between the application server and one or more transaction data storage devices;
obtain transaction data associated to one or more accounts related to a selected banking profile from each of the transaction data storage devices, wherein the data associated with transactions of said accounts stored at each of the transaction data storage devices includes a record of a transaction performed over a specific transaction rail; and
store the transaction data associated obtained from each of the transaction data storage devices in an aggregated data set associated with all the accounts of the selected banking profile.
